(19) United States
(12) Patent Application Publication
(10) Pub. No.: US 2014/0279338 A1
(43) Pub. Date: Sep. 18, 2014

(54) STANDARD DIAMOND PARCEL CERTIFICATION FOR EXCHANGE TRADED FUNDS

(71) Applicant: ROSY BLUE DMCC, Dubai (AE)

(72) Inventor: Dilip R. MEHTA, Dubai (AE)

(73) Assignee: ROSY BLUE DMCC, Dubai (AE)

(21) Appl. No.: 13/799,928

(22) Filed: Mar. 13, 2013

(51) Int. Cl. G06Q 30/00; G06Q 40/04

(52) U.S. Cl. CPC G06Q 30/018; G06Q 40/04
USPC 705/37; 705/317

(57) ABSTRACT

Standard Diamond Parcels (SDPs) are certified for use in Exchange Traded Funds (ETFs). Three SDP colour types, Luxury, Premium and Privilege along with seven weight ranges simplify the complexity of diamond trading into twenty one different types of SDPs. Each SDP has ten diamonds, each diamond having a different colour/clarity combination. An SDP certification device, method and durable, non-transitory computer readable storage medium assures the characteristic of the diamonds in of each SDP type have a uniform valuation even though characteristics of the individual diamonds in each SDP may vary. One or more SDP may be grouped for use in an EFT unit.

### FIELD OF THE DISCLOSURE

This present disclosure relates to an apparatus, method and computer readable medium product for certifying a standard diamond parcel (SDP). One or more SDPs may be included in an Exchange Traded Fund (ETF) unit.

### BACKGROUND

There is an immense interest in creating financial products based on naturally mined diamonds. The newer options which have emerged in this area include Exchange Traded Funds (ETF), which issue units based on the underlying physical asset. Pricing for natural diamonds when used with an ETF needs to consider the following market characteristics.

Transparency: In any valuation exercise for a financial product, it is important that characteristics of the underlying assets are vetted and confirmed by an independent third party. For diamonds, better quality and therefore higher value diamonds are usually priced and sold on the basis of grading certificates issued by independent laboratories who vet the characteristics of the diamond.

Nonlinear pricing: Each diamond can theoretically be priced uniquely. However in practice, diamonds are typically classified based on their qualities. Price differentiation can occur on the “4C's” of the diamonds, namely its Cut (Shape), Colour, Clarity and Carat (Weight). Prices in these categories move independently and their relative values change over time. Even for weight, the rate at which prices vary between weight bands are not linear.

Reducing the Complexity: Typically diamonds which can be considered “investment” quality by the diamond trade are available in over 175 colour, clarity and make combinations for every single shape and weight category. These become difficult for investors to understand and hence it is beneficial to reduce these into easily understandable ETF units.

### BRIEF DESCRIPTION OF THE DRAWINGS

The accompanying figures in which like reference numerals refer to identical or functionally similar elements throughout the separate views, and which together with the detailed description below are incorporated in and form part of the specification, serve to further illustrate various embodiments and to explain various principles and advantages in accordance with the present disclosure, in which:

FIG. 1 shows a representative block diagram of a system for facilitating a diamond based Exchange Traded Fund.

FIG. 2 shows a representative block diagram of a device for certifying a Standard Diamond Parcel.

FIG. 3 shows a representative flow diagram of the processes of the parcel qualification analysis module.

FIG. 4 shows a representative flow diagram of the processes of the caratage analysis module.

FIG. 5 shows a representative flow diagram of the processes of the type analysis module.

FIG. 6 shows a representative flow diagram of the processes of the distribution analysis module.

FIG. 7 shows a representative flow diagram of the processes of the WAC analysis module.

FIG. 8 shows a representative flow diagram of the processes of the SDP certification module.

### DETAILED DESCRIPTION

As required, detailed embodiments are disclosed herein; however, it is to be understood that the disclosed embodiments are merely examples and that the devices, systems and methods described herein can be embodied in various forms. Therefore, specific structural and functional details disclosed herein are not to be interpreted as limiting, but merely as a basis for the claims and as a representative basis for teaching one of ordinary skill in the art to variously employ the disclosed subject matter in virtually any appropriately detailed structure and function.

Diamonds which can be considered “investment” quality by the diamond trade are available in over 175 colour, clarity and make combinations for every single shape and weight category making it difficult for investors to understand. Reducing this number of combinations to as low as 23 easily understandable Standard Diamond Parcels (SDPs) simplifies the use of diamonds as a basis for an ETF investment vehicle.

In the diamond trade, a diamond is currently evaluated using more than 25 sets of parameters. Each of these parameters can affect the value of the diamond to varying degrees. However, standard parcels for use in the financial markets generally focus on the better quality diamonds or higher priced diamonds within the diamond qualities.

SDPs that are defined for each size category become the asset based on which the ETFs are created. The underlying asset of the ETFs can be a single SDP or any combination on SDPs based on the investment objective of the ETF. Hence the SDPs are the primary building blocks on which diamonds start to get traded transparently.

Aspects of SDPs reflect the manner in which diamonds are bought and sold in the diamond trade. This makes them more marketable and also easier for the diamond trade to understand and therefore be encouraged to supply, purchase the SDPs, and improve the acceptance and commercialization of SDPs.

The creation of SDPs has built-in flexibility with respect to their content. While product parameters are not overly broad to maintain their average quality, they are also not overly narrow in order to ensure that there is depth in the market for the diamonds identified in the SDP. Additionally the SDPs enable focusing on the range of goods which have healthy trading volumes.

Qualifying naturally mined diamonds are graded and certified by the Gemological Institute of America (GIA). Amongst the gem grading laboratories in the world, the GIA certifies the most number of diamonds, issuing nearly three million diamond grading certificates per annum. Parameters used by different laboratories vary slightly, which could result in different grades amongst laboratories for any given diamond. Accepting a single laboratory's certificate ensure consistency in the parameters. Other laboratories certificates are accepted if their standards match those used by the GIA.

Qualifying diamonds are untreated natural diamonds. Synthetic diamonds and/or diamonds treated for enhancing their properties will generally not qualify for the SDP. With the exceptions provided below, the diamonds are certified to possess the following basic characteristics: Proportion/Cut—Excellent (next grade down being Very Good); Polish—Excellent (next grade down being Very Good); Symmetry—Excellent (next grade down being Very Good); and Fluorescence—None or Slight. If another grading laboratory is approved for use in certifying diamonds for SDP qualification, then comparable grading scales from these laboratories can be specified.

Diamonds with the first three grading categories being Excellent are referred to in the diamond trade as Triple Excellent or EX-EX-EX stones. There is a huge interest in these stones, with demand from major international brands as well as emerging markets. The supply has also increased with many manufacturers around the world who are now capable of manufacturing higher quality polished diamonds that exhibit these characteristics. This has greatly increased the supply of this type of polished diamonds as they trade at a premium to standard quality polished diamonds. Polished diamonds with a Very Good (VG) certification on any of Proportion/Cut, Polish or Symmetry can be accepted for use in SDPs as well. These diamonds would be given a lower weighting when calculating Weighted Average Caratage (WAC) of the stones, through an additional weight. This will ensure that the Value per WAC of the parcel is maintained.

Clarity is a key grading category for the quality of the diamond. In the higher clarity goods, a few of the other grading categories become less influential in valuation, thereby reducing the variability in the pricing. Characteristics that materially influence the value of lower quality goods, such as the position and colour of inclusions, become less relevant in high clarity diamonds. The clarity grades that will be considered for SDPs include: IF (Internally Flawless); VVS1 and VVS2 (Very Very Slight Inclusion); and VS1 and VS2 (Very Slight Inclusion).

Colour and carat weight are the other two parameters. However different parcels can have variations in the colour and carat weights within an acceptable range.

Each SDP will consist of 10 polished diamonds. All 10 diamonds will fall within a predetermined carat weight range and have one of two predetermined colour grades. The SDPs have names for easier relation to their actual, commercial usage. The SDP names and their respective colour grades allowed within the parcels are as follows: Luxury SDP—E and F colour diamonds; Premium SDP—G and H colour diamonds; Privilege SDP—I and J colour diamonds. In this example, the colour grades of Luxury, Premium and Privilege do not overlap. For certified diamonds, the top colour grade which can be given is “D”. However, the stones of this colour grade are more difficult to source in the necessary quantities.

The stones in the SDPs will fall within the basic parameters which have been defined above. By way of example, the number of diamonds in each combination of qualifying characteristics within a SDP is shown. Each SDP has 10 stones. Within each parcel, each stone will have a different colour-clarity combination. The colour-clarity combinations for the 3 types of parcels, Luxury, Premium and Privilege are described below: A Luxury SDP has five stones of colour E with one in each of the five clarity ratings IF, VVS1, VVS2, VS1 and VS2 and another 5 stones of colour F with one stone in of each of the five clarities IF, VVS1, VVS2, VS1 and VS2. A Premium SDP has five stones of colour G with one in each of the five clarities IF, VVS1, VVS2, VS1 and VS2 and another 5 stones of colour H with one stone in of each of the five clarities IF, VVS1, VVS2, VS1 and VS2. A Privilege SDP has five stones of colour I with one in each of the five clarity ratings IF, VVS1, VVS2, VS1 and VS2 and another 5 stones of colour J with one stone in of each of the five clarifies IF, VVS1, VVS2, VS1 and VS2. Thus, each of the 10 stones in any of the parcel types have unique colour-clarity combinations.

SDPs also vary according to the carat weight of the diamonds acceptable within the SDP. There are 7 defined carat weight ranges for which SDPs are to be created: 0.50, 0.75, 1.00, 1.25, 1.50, 1.75, and 2.00 carats. The minimum acceptable Weighted Average Caratage (WAC) for any of the three Luxury, Premium, or Privilege SDP types is a function of the carat weight range of the SDP. The WAC (minimum value) for a 0.50 weight range is 0.52, or WAC(0.50)=0.52. The WACs and acceptable stone weights in brackets for all seven weight ranges are: WAC(0.50)=0.52 (0.50-0.60), WAC(0.75)=0.72 (0.70-0.80), WAC(1.00)=1.03 (1.00-1.10), WAC(1.25)=1.28 (1.25-1.35), WAC(1.50)=1.54 (1.50-1.65), WAC(1.75)=1.79 (1.75-1.90), and WAC(2.00)=2.05 (2.00-2.15). One benefit of this is that there is transparency on the actual stones contained in a given SDP when it is purchased or sold. This transparency will reduce the spreads that may occur in the trading of SDPs.

The parcels are based on the concept of a standardized “Weighted Average Carat” (WAC) predetermined for each parcel. WAC is defined on the actual weight of the stone multiplied by its weighting based on its colour and clarity. The weighting is calculated based on the relative price of the different colour and clarity stones within a parcel. This weighting ensures that there is consistency in the value of the parcel. Hence, if a lower carat weight stone of a higher priced category (either colour or clarity) is provided, it would mean that the WAC needs to be adjusted by using a much larger stone of a lower price category. This ensures that the average value per WAC of the parcel is consistent. The actual weighting for each of the 21 SDPs may be derived from a historical analysis of the prices or other sources may be changed while remaining within the scope of this description.

In an example based on a historical regression analysis of the pricing of each of these parcel combinations of color-clarity, a 1 carat Luxury Parcel assumes the weightage below where weightage=W as a function of colour and clarity. Given an E colour and an IF clarity and a weightage of 13.3%, then W(E/IF)=0.133. For the ten stones in a Luxury Parcel, W(E/IF)=0.133, W(ENVS1)=0.123, W(ENVS2)=0.105, W(ENS1)=0.087, W(E/VS2)=0.075, W(F/IF)=0.120, W(FNVS1)=0.108, W(FNVS2)=0.097, W(FNS1)=0.081, and W(E/VS2)=0.071.

The WAC (weight range) of a parcel is the sum of the products of each stones W(colour/clarity) and its weight. In the example table below, assume that all diamonds except for the E/IF and F/VS2 are available in a 1.03 carat weight.

| No | Clarity | Colour | Weightage | Carats | Product |
|---|---|---|---|---|---|
| 1 | IF | E | 0.133 | 1.00 | 0.1330 |
| 2 | VVS1 | E | 0.123 | 1.03 | 0.1267 |
| 3 | VVS2 | E | 0.105 | 1.03 | 0.1082 |
| 4 | VS1 | E | 0.087 | 1.03 | 0.0896 |
| 5 | VS2 | E | 0.075 | 1.03 | 0.0773 |
| 6 | IF | F | 0.120 | 1.03 | 0.1236 |
| 7 | VVS1 | F | 0.108 | 1.03 | 0.1112 |
| 8 | VVS2 | F | 0.097 | 1.03 | 0.0999 |
| 9 | VS1 | F | 0.081 | 1.03 | 0.0834 |
| 10 | VS2 | F | 0.071 | 1.09 | 0.0774 |

| | |
|---|---|
| Weighted Average Caratage (min WAC = 1.03) | 1.0303 |

However, if a shortage in the WAC was to be made up with a E/VS1 stone, then a minimum a 1.08 carat stone is needed. Numerous other combinations of stones may be used to reach the minimum WAC for a given weight range and colour grade. The approach is to ensure that once a Standard Diamond Parcel is created, each SDP is approximate in value to other parcels of the same SDP category and becomes replaceable with another parcel of the same SDP. This provides that trading can be done on units of SDPs, rather than carat weights of the respective parcels, as the value of the parcels of an SDP are approximately consistent and the complexity of trading diamonds is reduced to the 21 tradable SDPs, or twenty one different types of standard diamond parcels.

When accepting Very Good (VG) grade stones for cut, polish and/or symmetry in an SDP, an additional weighting criterion is used that was not calculated in the Excellent (EX) grade of the above table. The VG grade is inferior to the EX grade and this is often reflected in the price at which they are traded on the individual diamond market. Based on the historical analysis behind this price differential, an additional weight is introduced which allows for greater compensation through the higher weight of other stones. The additional weight would be 100% for all EX-EX-EX stones but would be lowered based on the parameter which is not an EX but a VG. In a simplified example, the product above would be reduced by another 5% for a VG-EX-EX stone. For example if stone number 1 in the table above was a VG-EX-EX, having a VG cut, and EX polish, and an EX symmetry, then its product would be 0.133 (weightage)*1.00 (carats)*0.95 (cut)*1.00 (polish)*1.00 (symmetry)=0.1264, which is a 5% reduction in the product of diamond 1 in the above table. To compensate for this reduction, one or more other diamonds in the parcel with corresponding colour, clarity and weight range but with a higher carat weight can be substituted for one or more of the other nine diamonds in order to meet the minimum WAC requirement of 1.03 for the above SDP. In another example if stone number 1 in the table above was a VG-EX-VG, having a VG cut, and EX polish, and VG symmetry, then its product would be 0.133 (weightage)*1.00 (carats)*0.95 (cut)*1.00 (polish)*0.95 (symmetry)=0.1200, which is a 9.75% reduction in the produce of diamond 1 in the above table. Similarly, to compensate for this reduction, one or more other diamonds in the parcel with corresponding colour, clarity and weight range and a higher carat weight can be substituted for one or more of the other nine diamonds in order to meet the minimum WAC requirement of 1.03 for the above SDP.

Once the SDPs have been formed, various financial products can then be launched. The ETFs are based on the Standard Exchange traded fund Parcels (SEPs), which are created by the sponsor and/or creator of the respective ETF. The SDPs trade in their physical form and not only in the financial product form, and the markets establish their pricing on the basis of their trades and the liquidity thereof. SEPs trade in the form of units rather than carat weight, as the value for each of the units is consistent. The actual price depends upon the price of its actual components. This ensures that the trading would be focused on a small set of SDPs bringing in liquidity and transparency to the market. In the simple example a SEP can be based on a single SDP, however, the sponsor can design the SEP to be based on a combination of SDPs based upon the desired exposure to be given to the market.

For example, a Luxury High Velocity ETF can be created based upon a Luxury High Velocity SEP. The SEP would consist of a total of five SDPs, two 0.50 Carat Luxury SDPs, two 0.75 Carat Luxury SDPs and one 1.00 Carat Luxury SDP. This gives the investor an exposure into the Luxury space by allowing them to take an exposure to goods which have a high velocity of sale and are also preferred by buyers who purchase from the global luxury branded jewelry chains. Other combinations of SDPs with other desired exposures are contemplated. Thus ETF units can be created that allows for creation of a multiple of ETFs targeting different investment objectives, keeping the building blocks of the ETFs simple and easy to understand, and ensure the clarity in the supply side for a sizable participation in the ETFs for the kind of goods which are supplied.

FIG. 1 shows a representative block diagram of a system for facilitating a diamond based Exchange Traded Fund. Polished diamonds 100 are graded a laboratory, such as the Gemological Institute of America and a GIA report 102 is a descriptive report produced for each diamond and is known to those familiar with the art of diamond grading. Ten diamonds are selected from the polished diamonds with their corresponding GIA reports 106 or ten descriptive reports or a multiplicity of descriptive reports to form a parcel of diamonds 104. The diamonds may be selected manually or with the aid of the devices and processes described herein. The GIA reports of the diamond parcel are analyzed by SDP certification process 108 and if meeting the requirements, the parcel is certified as a Standard Diamond Parcel 110. The SDP is stored in a secure storage area 112 and the GIA reports corresponding to the SDP are securely stored in GIA and SDP database 114. ETF units or Standard ETF Parcels (SEPs) 116 are created by bundling one or more SDPs and the corresponding GIA reports and bundling are stored in ETF/SEP database 118.

FIG. 2 shows a representative block diagram of a device for certifying a Standard Diamond Parcel. The GIA reports 106 of a diamond parcel 104 are processed by SDP certification device 208. The SDP certification device may be a computer based device operating computer instructions which may be stored on a non-transitory media. The GIA reports 106 are analyzed by qualification analysis module 210, the caratage analysis module 215, the type analysis module 220, the distribution analysis module 225, and the Weighted Average Caratage (WAC) module 230. If successful, the SDP certification module 235 assigns a SDP identification element 250 or a standard diamond certification element to the diamond parcel 104 enabling the parcel as a SDP and its storage in secure SDP storage area 112. The GIA reports associated with the SDP and the SDP ID are stored in secure database 270. One or more SDPs are then packaged into a SEP by SDP packaging module 260. ETF unit certification module 265 then assures the SDP meets the objectives and certifies the SDP as an ETF unit. The information related to the SDPs of the ETF unit including the standard diamond parcel identification element is then also stored in secured database 270 and the unit is released for use at the ETF market 120.

FIG. 3 shows a representative flow diagram of the processes of the parcel qualification analysis module. The flow diagram enters at step 300 and step 302 checks if GIA reports are available for all 10 diamonds in the parcel. If not then the parcel fails the qualification analysis at step 310. Otherwise step 304 checks if all GIA reports indicate a florescence equal to none or slight. If not then the parcel fails the qualification analysis at step 310. Otherwise, step 306 checks if all GIA reports indicate the cut, polish and symmetry are equal to excellent or very good. If not then the parcel fails the qualification analysis at step 310, otherwise the parcel passes the qualification analysis at step 308. The parcel qualification assures all diamonds in a SDP satisfy minimum requirements of a SDP.

FIG. 4 shows a representative flow diagram of the processes of the caratage analysis module. The flow diagram enters at step 400 and step 402 determines the parcel weight range. Parcel weight ranges are 0.50, 0.750, 1.00, 1.25, 1.50, 1.75, and 2.00 carats. In one example, to be within a certain weight range, all diamonds are equal to or greater than the weight specified of the certain weight range but less than the weight specified by the next higher weight range. In this example, the weight ranges do not overlap. Other weight ranges and weight range classifications are possible while remaining with the scope of this description. Step 404 checks if all stones in the parcel are within one weight range. If not then the parcel fails the caratage analysis at step 408. Otherwise the parcel passes the caratage analysis at step 406. The parcel caratage analysis determines that all diamonds in a SDP are within a limited weight range of a SDP.

FIG. 5 shows a representative flow diagram of the processes of the type analysis module. The flow diagram enters at step 500 and step 502 determines if all diamonds in the parcel are within a first and second colour range. A Luxury type parcel has diamonds with E and F colour ranges. A Premium type parcel has diamonds with G and H colour ranges. A Privilege parcel has diamonds with I and J colour ranges. Step 504 determines if all diamonds have colours within either the Luxury, Premium or Privilege types. If not then the parcel fails the parcel type analysis at step 508. Otherwise the parcel passes the parcel type analysis at step 506. The parcel type analysis determines that all diamonds in a SDP are within a limited colour range of a SDP.

FIG. 6 shows a representative flow diagram of the processes of the distribution analysis module. The flow diagram enters at step 600 and step 602 determines if a first diamond has an IF clarity in the first colour type and if a second diamond has an IF clarity in the second colour type. If not the parcel fails the distribution analysis at step 614. If so, step 604 determines if a third diamond has a VVS1 clarity in the first colour type and if a fourth diamond has a VVS1 clarity in the second colour type. If not the parcel fails the distribution analysis at step 614. If so, step 606 determines if a fifth diamond has a VVS2 clarity in the first colour type and if a sixth diamond has a VVS2 clarity in the second colour type. If not the parcel fails the distribution analysis at step 614. If so, step 608 determines if a seventh diamond has a VS1 clarity in the first colour type and if an eight diamond has a VS1 clarity in the second colour type. If not the parcel fails the distribution analysis at step 614. If so, step 610 determines if a ninth diamond has a VS2 clarity in the first colour type and if a tenth diamond has a VS2 clarity in the second colour type. If not the parcel fails the distribution analysis at step 614. If so, the parcel passes the distribution analysis at step 612. The parcel distribution analysis assures that each diamond in the parcel has a different and unique colour and clarity combination within the limited colour range and the limited clarity range of a SDP. While five diamonds in the parcel may have a common colour and two diamonds in the parcel may have a common clarity, no diamond in the parcel has a common combination of colour and clarity, thereby providing for the unique combination of colour and clarity for diamonds in the parcel.

FIG. 7 shows a representative flow diagram of the processes of the WAC analysis module. The flow diagram enters at step 700 and step 702 selects a first GIA report and initializes a variable WAC to 0.00. Step 704 sets the cut factor to 1.00 if the cut of the selected GIA report is excellent (EX), or the cut factor is set to 0.95 if the cut of the selected GIA report is very good (VG). Step 706 sets the polish factor to 1.00 if the polish of the selected GIA report is EX, or the polish factor is set to 0.95 if the polish factor of the selected GIA report is VG. Step 708 sets the symmetry factor to 1.00 if the symmetry of the selected GIA report is EX, or the symmetry factor is set to 0.95 if the symmetry of the selected GIA report is VG. Step 710 sets the weight factor to a value according to the table of step 710 dependent upon the colour and clarity of the selected GIA report. Step 712 accumulates the WAC by determining the product of the carat weight factor, weightage factor, symmetry factor, polish factor and the cut factor and summing the determined product into WAC. If in step 714 the last diamond in the parcel has not been selected then the next diamond GIA report is selected in step 716 and the flow diagram returns to step 704. Otherwise step 718 determines if the determined WAC is greater than or equal to the minimum WAC of the weight range of the parcel. The WAC of the seven weight ranges are: WAC(0.50)=0.52, WAC(0.75)=0.72, WAC(1.00)=1.03, WAC(1.25)=1.28, WAC(1.50)=1.54, WAC(1.75)=1.79, WAC(2.00)=2.05. If so, the parcel passes the WAC analysis at step 710, otherwise the parcel fails the WAC analysis at step 712. The WAC analysis assures that a SDP of a given type and weight range has comparable value without requiring that the diamonds of each SDP to have identical characteristics. The values used in the WAC analysis are example values; different values may be used in other examples while remaining within the scope of the description.

FIG. 8 shows a representative flow diagram of the processes of the SDP certification module. The flow diagram enters at step 800 and step 802 determines if the diamond parcel passes the WAC analysis performed by WAC analysis module 230 using the WAC analysis processes of FIG. 7, and if the diamond parcel passes the distribution analysis performed by distribution analysis module 225 using the distribution analysis processes of FIG. 6, and if the diamond parcel passes type analysis performed by the type analysis module 220 using the type analysis processes of FIG. 5, and if the diamond parcel passes the caratage analysis performed by the caratage analysis module 215 using the caratage analysis processes of FIG. 4, and if the diamond parcel passes the qualification analysis performed by the qualification analysis module 210 using the qualification analysis processes of FIG. 3. In not, the diamond parcel is rejected at step 822. Otherwise, the diamond parcel is certified as a SDP and a unique SDP identification number is issued to the parcel at step 812. Step 814 then assigns the SDP ID to GIA reports in the SDP which are then stored in a secure database at step 816. Step 818 then assigns the SDP ID to the physical diamond parcel itself and step 820 ensures storage of the SDP in a secure storage area. The process flow of FIG. 8 assures that only a diamond parcel that satisfies all of the requirements is certified as SDP.

It should be appreciated that a diamond parcel rejected at step 822 may be again submitted to the SDP certification device 208 if certain diamonds in the parcel are replaced in order to bring the parcel in compliance with SDP requirements. New GIA reports would be substituted in the group of GIA reports 106 corresponding to the new diamond parcel 104 and then resubmitted.

Also, multiple types of standard diamond parcels are provided for of differing weight ranges and colour ranges. However, all standard diamond parcels have a common distribution requirement, that is each of the ten diamonds have a unique colour clarity combination, with five being of one colour and five being of the other colour and two of each diamond having one of five clarity ratings, but no diamond having a common colour and clarity combination.

In a multiple diamond parcel example, given a first diamond parcel, then a standard diamond parcel certification device comprises: a qualification analysis module for passing a parcel of diamonds if each of a multiplicity of descriptive reports corresponding to each of a multiplicity of diamonds included within the parcel of diamonds indicates that the parcel of diamonds satisfies minimum qualifications; a caratage analysis module for passing the parcel of diamonds if each of the multiplicity of descriptive reports indicates a carat weight within a one weight range of a plurality of weight ranges; a type analysis module for passing the parcel of diamonds if each of the multiplicity of descriptive reports indicates a colour within a one colour range of a plurality of colour ranges; a distribution analysis module for passing the parcel of diamonds if each of the multiplicity of descriptive reports indicates a unique colour and clarity combination; a weighted average caratage analysis module for passing the parcel of diamonds if a sum of a weighted average caratage calculation for each of the multiplicity of descriptive reports exceeds a minimum amount corresponding to the one weight range of the plurality of weight ranges; and a standard diamond parcel certification module for assigning a standard diamond parcel identification element to the parcel of diamonds if the parcel of diamonds is passed by the qualification analysis module, the caratage analysis module, the type analysis module, the distribution analysis module and the weighted average caratage analysis module and further comprising an exchange traded fund unit certification module for including the standard diamond parcel identification element within an exchange traded fund unit and communicating the exchange traded fund unit to an exchange traded fund market.

Given a second diamond parcel with a different weight range from the first diamond parcel of the above multiple diamond parcel example, then the qualification analysis module passes a second parcel of diamonds if each of a second multiplicity of descriptive reports corresponding to each of a second multiplicity of diamonds included within the second parcel of diamonds indicates that the second parcel of diamonds satisfies the minimum qualifications, the caratage analysis module passes the second parcel of diamonds if each of the second multiplicity of descriptive reports indicates a second carat weight within a second weight range of the plurality of weight ranges, the type analysis module passes the second parcel of diamonds if each of the second multiplicity of descriptive reports indicates a colour within the one colour range of the plurality of colour ranges, the distribution analysis module passes the second parcel of diamonds if each the multiplicity of descriptive reports indicates the unique colour and clarity combination, the weighted average carat analysis module passes the second parcel of diamonds if the sum of the weighted average caratage calculation for each the second multiplicity of descriptive reports exceeds a second minimum amount corresponding to the second of the plurality of weight ranges, the standard diamond parcel certification module assigns a second standard diamond parcel identification element to the second parcel of diamonds if the second parcel of diamonds is passed by the qualification analysis module, the caratage analysis module, the type analysis module, the distribution analysis module and the weighted average caratage analysis module, and the exchange traded fund unit certification module includes the second standard diamond parcel identification element within the exchange traded fund unit.

Or given a second diamond parcel with a different colour range from the first diamond parcel in the above multiple diamond parcel example then the qualification analysis module passes a second parcel of diamonds if each of a second multiplicity of descriptive reports corresponding to each of a second multiplicity of diamonds included within the second parcel of diamonds indicates that the second parcel of diamonds satisfies the minimum qualifications, the caratage analysis module passes the second parcel of diamonds if each of the second multiplicity of descriptive reports indicates a carat weight within the one weight range of the plurality of weight ranges, the type analysis module passes the second parcel of diamonds if each of the second multiplicity of descriptive reports indicates a colour within a second colour range of the plurality of colour ranges, the distribution analysis module passes the second parcel of diamonds if each of the second multiplicity of descriptive reports indicates the unique colour and clarity combination, the weighted average carat analysis module passes the second parcel of diamonds if the sum of the weighted average caratage calculation for each the second multiplicity of descriptive reports exceeds the minimum amount corresponding to the one of the plurality of weight ranges, the standard diamond parcel certification module assigns a second standard diamond parcel identification element to the second parcel of diamonds if the second parcel of diamonds is passed by the qualification analysis module, the caratage analysis module, the type analysis module, the distribution analysis module and the weighted average caratage analysis module, and the exchange traded fund unit certification module includes the second standard diamond parcel identification element within the exchange traded fund unit.

Or given a second diamond parcel with a different weight range and a different colour range from the first diamond parcel in the above multiple diamond parcel example then the qualification analysis module for passes a second parcel of diamonds if each of a second multiplicity of descriptive reports corresponding to each of a second multiplicity of diamonds included within the second parcel of diamonds indicates that the second parcel of diamonds satisfies the minimum qualifications, the caratage analysis module passes the second parcel of diamonds if each of the second multiplicity of descriptive reports indicates a carat weight within a second weight range of the plurality of weight ranges, the type analysis module passes the second parcel of diamonds if each of the second multiplicity of descriptive reports indicates a colour within a second colour range of the plurality of colour ranges, the distribution analysis module passes the parcel of diamonds if each of the second multiplicity of descriptive reports indicates the unique colour and clarity combination, the weighted average carat analysis module passes the second parcel of diamonds if the sum of the weighted average caratage calculation for each the second multiplicity of descriptive reports exceeds a second minimum amount corresponding to the second weight range, the standard diamond parcel certification module assigns a second standard diamond parcel identification element to the second parcel of diamonds if the second parcel of diamonds is passed by the qualification analysis module, the caratage analysis module, the type analysis module, the distribution analysis module and the weighted average caratage analysis module, and the exchange traded fund unit certification module includes the second standard diamond parcel identification element within the exchange traded fund unit.

In an alternate example of a SDP, an SDP may consist of six stones of a common clarity and carot weight range and with a distribution of six different colours. Given the seven defined weight ranges: 0.50, 0.75, 1.00, 1.25, 1.50, 1.75, and 2.00 carats, and the five defined clarifies: IF, VVS1, VVS2, VS1, and VS2, then thirty five different SDPs may be defined with this distribution. As one of ordinary skill in the art would appreciate, the figures (e.g. FIGS. 5-7), which were based on a colour based parcel, would change to reflect a clarity based parcel. The table below shows a SDP having a common weight range of 1.00 and a common clarity of VVS2 with a distribution of colours E, F, G, H, I, and J.

| No | Clarity | Colour | Weightage | Carats | Product |
|---|---|---|---|---|---|
| 1 | VVS2 | E | 0.105 | 1.00 | 0.1330 |
| 2 | VVS2 | F | 0.087 | 1.03 | 0.1267 |
| 3 | VVS2 | G | 0.072 | 1.03 | 0.1082 |
| 4 | VVS2 | H | 0.060 | 1.03 | 0.0896 |
| 5 | VVS2 | I | 0.050 | 1.03 | 0.0773 |
| 6 | VVS2 | J | 0.042 | 1.12 | 0.1236 |

| | |
|---|---|
| Weighted Average Caratage (min WAC = 0.428) | 0.429 |

This is an acceptable SDP because the calculated WAC of 0.429 is greater than the minimum WAC 0.428. Note that the weightage values and WAC for a SDP shown in this example are for illustration purposes, other values may be used while remaining within the scope of the description. In the example above, the higher weight of stone 6 compensates for the lower weight of stone 1. As previously described, additional compensation for departure from the EX-EX-EX cut, polish and/or symmetry of each stone may be incorporated into this example.

The terms and phrases used herein are not intended to be limiting, but rather, to provide an understandable description. Likewise, any values shown in the figures are for demonstration purposes only. Additionally, unless otherwise specifically expressed or clearly understood from the context of use, a term as used herein describes the singular or the plural of that term.

The terms “a” or “an”, as used herein, are defined as one or more than one. The term “plurality”, as used herein, is defined as two or more than two. The term “another”, as used herein, is defined as at least a second or more. The terms “including” and “having,” as used herein, are defined as comprising (i.e., open language). The term “coupled,” as used herein, is defined as “connected,” although not necessarily directly, and not necessarily mechanically. “Communicatively coupled” refers to coupling of components such that these components are able to communicate with one another through, for example, wired, wireless or other communications media. The term “communicatively coupled” or “communicatively coupling” includes, but is not limited to, communicating electronic control signals by which one element may direct or control another. The term “configured to” describes hardware, software or a combination of hardware and software that is adapted to, set up, arranged, commanded, altered, modified, built, composed, constructed, designed, or that has any combination of these characteristics to carry out a given function. The term “adapted to” describes hardware, software or a combination of hardware and software that is capable of, able to accommodate, to make, or that is suitable to carry out a given function.

The terms “controller”, “computer”, “server”, “client”, “computer system”, “computing system”, “personal computing system”, or “processing system” describe examples of a suitably configured processing system adapted to implement one or more embodiments of the present disclosure. Any suitably configured processing system is similarly able to be used by embodiments of the present disclosure, for example and not for limitation, a personal computer, a laptop computer, a tablet computer, a personal digital assistant, a workstation, or the like. A processing system may include one or more processing systems or processors. A processing system can be realized in a centralized fashion in one processing system or in a distributed fashion where different elements are spread across several interconnected processing systems.

The terms “computing system”, “computer system”, and “personal computing system”, describe a processing system that includes a user interface and which is suitably configured and adapted to implement one or more embodiments of the present disclosure. The terms “network”, “computer network”, “computing network”, and “communication network”, describe examples of a collection of computers and devices interconnected by communications channels that facilitate communications among users and allows users to share resources.

The present subject matter can be realized in hardware, software, or a combination of hardware and software. A system can be realized in a centralized fashion in one computer system, or in a distributed fashion where different elements are spread across several interconnected computer systems. Any kind of computer system—or other apparatus adapted for carrying out the methods described herein—is suitable.

The present subject matter can also be embedded in a computer program product, which comprises all the features enabling the implementation of the methods described herein, and which—when loaded in a computer system—is able to carry out these methods. Computer program in the present context means any expression, in any language, code or notation, of a set of computer instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, computer instructions, messages or message packets, and other computer readable information from the computer readable medium. The computer readable medium may include computer readable storage medium tangibly embodying non-volatile memory, such as read-only memory (ROM), flash memory, disk drive memory, CD-ROM, and other permanent storage. Additionally, a durable non-transitory computer readable storage medium may include tangibly embodied volatile storage such as RAM, buffers, cache memory, and network circuits. Furthermore, according to various other embodiments, the computer readable medium may comprise computer readable information in a transitory state medium such as a network link and/or a network interface, including a wired network or a wireless network that allow a computer to read such computer readable information.

Although specific embodiments of the subject matter have been disclosed, those having ordinary skill in the art will understand that changes can be made to the specific embodiments without departing from the spirit and scope of the disclosed subject matter. The scope of the disclosure is not to be restricted, therefore, to the specific embodiments, and it is intended that the appended claims cover any and all such applications, modifications, and embodiments within the scope of the present disclosure.

What is claimed is:

1. A standard diamond parcel certification device comprising:
a qualification analysis module for passing a parcel of diamonds if each of a multiplicity of descriptive reports corresponding to each of a multiplicity of diamonds included within the parcel of diamonds indicates that the parcel of diamonds satisfies minimum qualifications;
a caratage analysis module for passing the parcel of diamonds if each of the multiplicity of descriptive reports indicates a carat weight within a one weight range of a plurality of weight ranges;
a type analysis module for passing the parcel of diamonds if each of the multiplicity of descriptive reports indicates a colour within a one colour range of a plurality of colour ranges;
a distribution analysis module for passing the parcel of diamonds if each of the multiplicity of descriptive reports indicates a unique colour and clarity combination;
a weighted average caratage analysis module for passing the parcel of diamonds if a sum of a weighted average caratage calculation for each of the multiplicity of descriptive reports exceeds a minimum amount corresponding to the one weight range of the plurality of weight ranges; and
a standard diamond parcel certification module for assigning a standard diamond parcel identification element to the parcel of diamonds if the parcel of diamonds is passed by the qualification analysis module, the caratage analysis module, the type analysis module, the distribution analysis module and the weighted average caratage analysis module.

2. The standard diamond parcel certification device according to claim 1 further comprising an exchange traded fund unit certification module for including the standard diamond parcel identification element within an exchange traded fund unit and communicating the exchange traded fund unit to an exchange traded fund market.

3. The standard diamond parcel certification device according to claim 1 wherein the one weight range does not overlap with another weight range of the plurality of weight ranges.

4. The standard diamond parcel certification device according to claim 1 wherein the one colour range does not overlap with another colour range of the plurality of colour ranges.

5. The standard diamond parcel certification device according to claim 4 wherein the one weight range does not overlap with another weight range of the plurality of weight ranges.

6. The standard diamond parcel certification device according to claim 1 wherein the multiplicity of descriptive reports consists of ten descriptive reports and each of the multiplicity of descriptive reports includes one of a multiplicity of colours and one of at least five clarity ratings including an IF clarity, a VSS1 clarity, a VSS2 clarity, a VS1 clarity and a VS2 clarity, and the one colour range includes a first colour and a second colour of the multiplicity of colours the second colour being of lower quality than the first colour, and the distribution analysis module passes the parcel of diamonds if
a first of the ten descriptive reports indicates the IF clarity and the first colour,
a second of the ten descriptive reports indicates the VVS1 clarity and the first colour,
a third of the ten descriptive reports indicates the VVS2 clarity and first colour,
a fourth of the ten descriptive reports indicates the VS1 clarity and the first colour,
a fifth of the ten descriptive reports indicates the VS2 clarity and the first colour,
a sixth of the ten descriptive reports indicates the IF clarity and the second colour,
a seventh of the ten descriptive reports indicates the VVS1 clarity and the second colour,
an eighth of the ten descriptive reports indicates the VVS2 clarity and the second colour,
a ninth of the ten descriptive reports indicates the VS1 clarity and the second colour, and
a tenth of the ten descriptive reports indicates the VS2 clarity and the second colour.

7. The standard diamond parcel certification device according to claim 6 wherein the plurality of weight ranges consists of seven weight ranges which do not overlap and
a first of the seven weight ranges has a 0.50 minimum carat weight and a 0.52 minimum amount,
a second of the seven weight ranges has a 0.75 minimum carat weight and a 0.77 minimum amount,
a third of the seven weight ranges has a 1.00 minimum carat weight and a 1.03 minimum amount,
a fourth of the seven weight ranges has a 1.25 minimum carat weight and a 1.28 minimum amount,
a fifth of the seven weight ranges has a 1.50 minimum carat weight and a 1.54 minimum amount,
a sixth of the seven weight ranges has a 1.75 minimum carat weight and a 1.79 minimum amount, and
a seventh of the seven weight ranges has a 2.00 minimum carat weight and a 2.05 minimum amount, and
the weighted average caratage calculation sums
the product of 0.133 and the first descriptive report carat weight with
the product of 0.123 and the second descriptive report carat weight with
the product of 0.105 and the third descriptive report carat weight with
the product of 0.087 and the fourth descriptive report carat weight with
the product of 0.075 and the fifth descriptive report carat weight with
the product of 0.120 and the sixth descriptive report carat weight with
the product of 0.108 and the seventh descriptive report carat weight with
the product of 0.097 and the eight descriptive report carat weight with
the product of 0.081 and the ninth descriptive report carat weight with
the product of 0.071 and the tenth descriptive report carat weight.

8. The standard diamond parcel certification device according to claim 2 in wherein:
the qualification analysis module passes a second parcel of diamonds if each of a second multiplicity of descriptive reports corresponding to each of a second multiplicity of diamonds included within the second parcel of diamonds indicates that the second parcel of diamonds satisfies the minimum qualifications,
the caratage analysis module passes the second parcel of diamonds if each of the second multiplicity of descriptive reports indicates a second carat weight within a second weight range of the plurality of weight ranges,
the type analysis module passes the second parcel of diamonds if each of the second multiplicity of descriptive reports indicates a colour within the one colour range of the plurality of colour ranges,
the distribution analysis module passes the second parcel of diamonds if each the multiplicity of descriptive reports indicates the unique colour and clarity combination,
the weighted average carat analysis module passes the second parcel of diamonds if the sum of the weighted average caratage calculation for each the second multiplicity of descriptive reports exceeds a second minimum amount corresponding to the second of the plurality of weight ranges,
the standard diamond parcel certification module assigns a second standard diamond parcel identification element to the second parcel of diamonds if the second parcel of diamonds is passed by the qualification analysis module, the caratage analysis module, the type analysis module, the distribution analysis module and the weighted average caratage analysis module, and
the exchange traded fund unit certification module includes the second standard diamond parcel identification element within the exchange traded fund unit.

9. The standard diamond parcel certification device according to claim 2 in wherein:
the qualification analysis module passes a second parcel of diamonds if each of a second multiplicity of descriptive reports corresponding to each of a second multiplicity of diamonds included within the second parcel of diamonds indicates that the second parcel of diamonds satisfies the minimum qualifications,
the caratage analysis module passes the second parcel of diamonds if each of the second multiplicity of descriptive reports indicates a carat weight within the one weight range of the plurality of weight ranges,
the type analysis module passes the second parcel of diamonds if each of the second multiplicity of descriptive reports indicates a colour within a second colour range of the plurality of colour ranges,
the distribution analysis module passes the second parcel of diamonds if each of the second multiplicity of descriptive reports indicates the unique colour and clarity combination,
the weighted average carat analysis module passes the second parcel of diamonds if the sum of the weighted average caratage calculation for each the second multiplicity of descriptive reports exceeds the minimum amount corresponding to the one of the plurality of weight ranges,
the standard diamond parcel certification module assigns a second standard diamond parcel identification element to the second parcel of diamonds if the second parcel of diamonds is passed by the qualification analysis module, the caratage analysis module, the type analysis module, the distribution analysis module and the weighted average caratage analysis module, and
the exchange traded fund unit certification module includes the second standard diamond parcel identification element within the exchange traded fund unit.

10. The standard diamond parcel certification device according to claim 2 in wherein:
the qualification analysis module passes a second parcel of diamonds if each of a second multiplicity of descriptive reports corresponding to each of a second multiplicity of diamonds included within the second parcel of diamonds indicates that the second parcel of diamonds satisfies the minimum qualifications,
the caratage analysis module passes the second parcel of diamonds if each of the second multiplicity of descriptive reports indicates a carat weight within a second weight range of the plurality of weight ranges,
the type analysis module passes the second parcel of diamonds if each of the second multiplicity of descriptive reports indicates a colour within a second colour range of the plurality of colour ranges,
the distribution analysis module passes the parcel of diamonds if each of the second multiplicity of descriptive reports indicates the unique colour and clarity combination,
the weighted average carat analysis module passes the second parcel of diamonds if the sum of the weighted average caratage calculation for each the second multiplicity of descriptive reports exceeds a second minimum amount corresponding to the second weight range,
the standard diamond parcel certification module assigns a second standard diamond parcel identification element to the second parcel of diamonds if the second parcel of diamonds is passed by the qualification analysis module, the caratage analysis module, the type analysis module, the distribution analysis module and the weighted average caratage analysis module, and
the exchange traded fund unit certification module includes the second standard diamond parcel identification element within the exchange traded fund unit.

11. A standard diamond parcel certification method comprising:
passing a qualification analysis of a parcel of diamonds if each of a multiplicity of descriptive reports corresponding to each of a multiplicity of diamonds included within the parcel of diamonds indicates that the parcel of diamonds satisfies minimum qualifications;
passing a caratage analysis of the parcel of diamonds if each of the multiplicity of descriptive reports indicates a carat weight within a one weight range of a plurality of weight ranges;
passing a type analysis of the parcel of diamonds if each of the multiplicity of descriptive reports indicates a colour within a one colour range of a plurality of colour ranges;
passing a distribution analysis of the parcel of diamonds if each of the multiplicity of descriptive reports indicates both a clarity range within a plurality of clarity ranges a unique colour and clarity combination;
passing a weighted average caratage analysis of the parcel of diamonds if a sum of a weighted average caratage calculation for each of the multiplicity of descriptive reports exceeds a minimum amount corresponding to the one weight range of the plurality of weight ranges; and
assigning a standard diamond parcel identification element to the parcel of diamonds if the parcel of diamonds is passed by the qualification analysis, the caratage analysis, the type analysis, the distribution analysis and the weighted average caratage analysis.

12. The method according to claim 11 further comprising:
including the standard diamond parcel identification element within an exchange traded fund unit; and
communicating the exchange traded fund unit to an exchange traded fund market.

13. The method according to claim 11 wherein the one colour range does not overlap with another colour range of the plurality of colour ranges.

14. The method according to claim 13 wherein the one weight range does not overlap with another weight range of the plurality of weight ranges.

15. The method according claim 14 wherein the plurality of weight ranges equals seven, the plurality of clarity ranges equals five, the multiplicity of diamonds included within the parcel equals six and the plurality of colour ranges equals six, each colour range having one unique colour, thereby providing for thirty five different types of standard diamond parcels of six diamonds of six unique colours within common weight and clarity ranges.

16. The method according claim 14 wherein the plurality of weight ranges equals seven, the multiplicity of diamonds included within the parcel equals ten and the plurality of colour ranges equals three, each colour range having two unique colours, thereby providing for twenty one different types of standard diamond parcels of ten diamonds with unique colour clarity combinations.

17. The method according to claim 11 further comprising the steps of:
packaging a plurality of standard diamond parcels into standard exchange traded fund parcel;
certifying the standard exchange traded fund parcel as an exchange traded fund unit; and
providing the exchange traded fund unit to an exchange traded fund market.

18. A durable, non-transitory computer readable storage medium comprising a computer program which instructs a computer to perform an automated method of aggregating data for a database, the method comprising:
passing a qualification analysis of a parcel of diamonds if each of a multiplicity of descriptive reports corresponding to each of a multiplicity of diamonds included within the parcel of diamonds indicates that the parcel of diamonds satisfies minimum qualifications;
passing a caratage analysis of the parcel of diamonds if each of the multiplicity of descriptive reports indicates a carat weight within a one weight range of a plurality of weight ranges;
passing a type analysis of the parcel of diamonds if each of the multiplicity of descriptive reports indicates a colour within a one colour range of a plurality of colour ranges;
passing a distribution analysis of the parcel of diamonds if each of the multiplicity of descriptive reports indicates a unique colour and clarity combination;
passing a weighted average caratage analysis of the parcel of diamonds if a sum of a weighted average caratage calculation for each of the multiplicity of descriptive reports exceeds a minimum amount corresponding to the one weight range of the plurality of weight ranges; and
assigning a standard diamond parcel identification element to the parcel of diamonds if the parcel of diamonds is passed by the qualification analysis, the caratage analysis, the type analysis, the distribution analysis and the weighted average caratage analysis.

19. The method according to claim 18 wherein the one colour range does not overlap with another colour range of the plurality of colour ranges, the one weight range does not overlap with another weight range of the plurality of weight ranges, and the plurality of weight ranges equals seven and the plurality of colour ranges equals three thereby providing for twenty one different types of standard diamond parcels.

20. The method according to claim 19 further comprising the steps of:
packaging a plurality of standard diamond parcels into standard exchange traded fund parcel;
certifying the standard exchange traded fund parcel as an exchange traded fund unit; and
providing the exchange traded fund unit to an exchange traded fund market.
